(19) United States
(12) Patent Application Publication
(10) Pub. No.: US 2020/0030847 A1
(43) Pub. Date: Jan. 30, 2020

(54) METHOD FOR PLASMA COATING ON THERMOPLASTIC

(71) Applicant: SABIC GLOBAL TECHNOLOGIES B.V., Bergen op Zoom (NL)

(72) Inventors: Shahram SHAFAEI, Bergen op Zoom (NL); Robert Dirk VAN DE GRAMPEL, Tholen (NL)

(21) Appl. No.: 16/337,672

(22) PCT Filed: Sep. 29, 2017
(86) PCT No.: PCT/IB2017/056022

§ 371 Date: Mar. 28, 2019

Related U.S. Application Data
(60) Provisional application No. 62/402,567, filed on Sep. 30, 2016.

(51) Int. Cl. B05D 7/04; B05D 1/00

(52) U.S. Cl. CPC B05D 7/04; B05D 2518/10; B05D 2201/02; B05D 1/62

(57) ABSTRACT

A composite material, and methods of making thereof, include a polycarbonate substrate and plasma-enhanced chemical vapor deposition formed layers. In particular, a film formed by a process of plasma-enhanced chemical vapor deposition includes: applying a radio frequency bias to a substrate; and supplying a process gas through an antennae, where microwave power applied to the antennae generates plasma of the process gas at the surface of the substrate thereby forming one or more layers on the substrate. In certain aspects the film exhibits one or more (or all) of favorable oxygen transmission rate, barrier improvement factor, optical transmission, surface roughness, chemical resistance and surface roughness properties.

### TECHNICAL FIELD

The present disclosure generally relates to plasma-enhanced chemical vapor deposition and the application of layers to substrate surfaces.

### BACKGROUND

Packaging materials used for perishable items are typically composites which include one or more substrates or layers or films that are laminated together. Polymeric substrates are often used in these laminates and can be of varying thicknesses, from that of thin films to much thicker films. To protect the perishables stored in such packaging materials, films that form the packaging material should provide a diffusion barrier thereby limiting permeability of oxygen and moisture through the film. Silicon oxide (SiOₓ) films exhibit barrier properties and are often applied to an appropriate plastic or thermoplastic substrate. Plasma-enhanced chemical vapor deposition (PECVD) processes have been used to introduce a barrier layer, such as SiOₓ, to an appropriate thermoplastic substrate. Processing and storage conditions of certain packaging materials may be damaging and ultimately affect the barrier ability and properties of the composite material.

### SUMMARY

Aspects of the present disclosure relate to a film formed by a process of plasma-enhanced chemical vapor deposition, the process comprising: applying a radio frequency bias to a substrate; and supplying a process gas through an antennae, where microwave power applied to the antennae generates plasma of the process gas at the surface of the substrate thereby forming one or more layers on the substrate. The film satisfies in some aspects one or more of the following: has an oxygen transmission rate of between about 10⁻⁶ cm³/m²·day·bar to about 1 cm³/m²·day·bar when measured in accordance with ISO 15105-2; exhibits a barrier improvement factor of greater than 1000 when compared to a substantially similar substrate; exhibits a transmission of greater than about 88% at a 2.5 mm, or at about 2.5 mm, film thickness; exhibits a surface roughness substantially similar to the surface roughness of a substantially similar substrate; exhibits chemical resistance to organic solvents; and the film a surface roughness of less than about 2 nm.

In further aspects the disclosure relates to a method for microwave and radio frequency plasma-enhanced chemical vapor deposition on a substrate, the method comprising: activating a surface of a polycarbonate substrate by treating the surface with an inert gas; generating a dual-frequency plasma of a process gas by causing a radio frequency signal to be applied to the polycarbonate substrate and by causing microwave power to be applied to the process gas at the polycarbonate substrate; and depositing one or more layers adjacent the surface of the polycarbonate substrate to form a film comprising the polycarbonate substrate and the one or more layers. The film in some aspects exhibits an oxygen transmission rate of between about 10⁻⁶ cm³/m²·day·bar to about 1 cm³/m²·day·bar when measured in accordance with ISO 15105-2.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE DRAWINGS

A more detailed understanding may be had from the following description, given by way of example in conjunction with the accompanying drawings.

FIG. 1 illustrates a schematic of a device for microwave radio frequency plasma-enhanced chemical vapor deposition.

FIG. 2 illustrates a schematic of a device for microwave radio frequency plasma-enhanced chemical vapor deposition with the antenna and substrate enhanced in detail.

FIG. 3 provides the surface roughness with height profile for SiOₓ coated polycarbonate film by compact MW-RF PECVD with Rmvis of 1.42 nm and OTR of 0.7 cm³/m²·day·bar.

FIG. 4 provides the surface roughness with height profile for SiOₓ coated polycarbonate film by compact LRF-PECVD with Rmvis of 14.2 nm and OTR of 63.4 cm³/m²·day·bar

FIG. 5 provides the surface roughness with height profile of the line is presented for non-coated PC with R_{RMS} of 0.33 nm and OTR of 1000 cm³/m²·day·bar.

### DETAILED DESCRIPTION

Plasma coating technologies, such as plasma-enhanced chemical vapor deposition (PECVD), have been used to deposit a silicone oxide diffusion barrier layer to thermoplastics for use in, for example, electronics, medications, automotive parts, and packaging perishables. However, existing plasma coating technologies are accompanied by certain disadvantages; elevated costs of plasma coating processes, instability of coated films at elevated temperatures, and permeability of the coated films which can reduce shelf life. It is desirable for packaging materials to maintain transparency and barrier performance after high heat conditions, upon moisture exposure, or autoclaving. The materials and related processes of making thereof provide microwave radio frequency PECVD silica (SiOₓ) coated substrates that is cost-effective, resilient, recyclable, and versatile from a linear microwave quartz and copper plasma source.

The packaging for sensitive goods, such as certain electronics, perishables, foodstuffs and medications, typically provide a diffusion barrier to prevent gas permeation and possible deterioration of these goods. The diffusion barrier protects items that may be damaged by oxygen or moisture, or retains properties of the article, including flavor or texture. While thermoplastics provide a structural alternative to bulky or fragile glass packaging, thermoplastics may be more permeable and thus often require additional features to achieve a sufficient diffusion barrier. For example, in many applications of polyethylene terephthalate (PET), a widely used plastic for packaging, the thermoplastic requires improved barrier properties.

Chemical additives may be introduced to the thermoplastic during production in order to trap permeants (or, the permeating species). However, these additives are usually tuned to specific permeants thereby narrowing the barrier function. Multilayers of different thermoplastic polymers have been used where one polymer layer exhibits improved barrier performance. Still, multilayer systems give rise to recycling concerns. The diffusion barrier performance of thermoplastic materials can also be improved by the deposition of thin oxide or metal films. Diamond-like coating (DLC), formed from deposited amorphous carbon layers, has been used to improve the diffusion barrier of PET bottles against oxygen and organic vapors. The DLC coating however is not transparent and typically alters the aesthetics of the coated film. Silicon dioxide films, which have excellent barrier properties, have been employed as coatings in packaging films because of their optical transparency, recyclability and suitability for microwaving. Silicon has been coated on PET films by means of pulsed microwave low-pressure plasma processes, but the method may be inappropriate for high heat packaging applications as PET has a glass transition temperature (T_{g}) of about 76° C. causing film deformations and hazing at temperatures in excess of the T_{g}. The present disclosure provides polycarbonate based, silicon oxide coated composite materials that maintain their barrier properties, surface properties, and transparency after high heat conditions and moisture exposure.

In various aspects, one or more layers may be deposited on a polycarbonate substrate via a plasma-enhanced chemical vapor deposition (PECVD) process, such as microwave radio frequency plasma-enhanced chemical vapor deposition. PECVD provides a versatile method for coating of temperature-sensitive materials including thermoplastics. PECVD is a non-equilibrium process in that the energy for the conversion of reactants is provided by energetic electrons, while the substrate temperature can remain low (typically below 100 degrees Celsius (° C.)).

PECVD involves the generation of plasma from a process gas configured to a plasma source such that the generated plasma may be deposited as a solid-state film or layer on a desired substrate. PECVD uses electrical energy to generate a glow discharge (i.e., a plasma) where the energy has been conveyed to a gas mixture, here a process gas. The gas is transformed into active species including radicals, ions, neutral atoms and molecules, and other highly excited species. The active species may be derived in the plasma by many simultaneous reactions from the monomer process gas and the species thereof. They contribute to a heterogeneous film growth on the substrate via polymerization among the active species, particularly among free radicals. The composite material described herein may be prepared from a PECVD process where a plasma source is applied to a process gas to generate a plasma that may be deposited as a film on the surface of a pre-treated substrate. The substrate may comprise a thermoplastic polymer, particularly a polycarbonate substrate.

To facilitate growth at the polycarbonate substrate, the polycarbonate may be pre-treated. Treatment may comprise contacting the surface of the polycarbonate substrate for deposition with an inert precursor process gas. The inert precursor process gas may comprise, for example, argon, oxygen, hydrogen (H₂), helium, or nitrogen, or a combination thereof The polycarbonate substrate may be treated to remove surface contaminants and to activate functional groups at the substrate surface. The surface of the polycarbonate substrate is prepared for the exchange of ions and adsorption of radical species generated during PECVD. The treatment primes the polycarbonate substrate for adhesion of deposited layers from a process gas. In an example, treatment prepares the PC substrate for deposition of an adhesion-promoting layer.

A process gas refers to the gas from which a process plasma is formed according to the methods provided herein. The formed plasma may be deposited in a solid-state as one or more layers on the polycarbonate substrate to form the composite material of the present disclosure. The process gas may comprise an organosilicon compound to provide a SiOx coating on the polycarbonate substrate during PECVD. Exemplary process gases may include, but are not limited to, tetraethoxysilane (TEOS), tetramethoxysilane (TMOS), and hexamethyldisilazane (HMDS), hexamethyldisiloxane (HMDSO). At least a portion of the process gas may comprise an excitation gas to facilitate the generation of active species for plasma formation. As excitation gas may comprise mostly oxygen O₂, nitrous oxide N₂O, or a mixture of O₂ and nitrogen N₂.

The polycarbonate substrate may be maintained at temperature and pressure conditions to facilitate the formation of plasma from the process gas and deposition of layers at the surface of the substrate. The polycarbonate substrate may be maintained at a temperature between about 25° C. and about 140° C. In some aspects, the deposition process may occur under a vacuum atmosphere or under low pressure conditions. For example, plasma deposition at the polycarbonate substrate may occur at a pressure from about 1×10⁻⁴ Pascals (Pa) to about 10 Pa.

Common plasma sources for conversion of the process gas (or the precursor process gas) to the active species may include alternating electric fields. For example, an alternating electric field may be used to generate and sustain a plasma from a process gas in a low pressure environment. Plasma sources may be operated at a wide range of frequencies including the kilohertz, kHz (radio frequency, RF) to the gigahertz, GHz (microwave, MW) range. Frequencies of a few tens of Hz to a few thousand Hz can produce time-varying plasmas that are repeatedly initiated and extinguished; frequencies of tens of kilohertz to tens of megahertz may result in reasonably time-independent glow discharges.

In certain aspects of the present disclosure, the plasma source may be operated at a dual frequency for the generation of a dual-frequency plasma. A plasma source as described herein may use a radio frequency of 13.56 megahertz (MHz)(or higher harmonics thereof) and a 2.45 GHz microwave frequency providing a Compact MW-RF PECVD. An applied amplitude may be applied between about 25 volts and about 60 volts. A deposition time for the MW-RF PECVD system may be up to about ten seconds. In a specific example, the deposition time may take place in fewer than five seconds.

Microwave and radio frequencies may be provided from any number of conventional sources. A genitor may be used as the microwave power source to deliver microwave radiation to the system for plasma deposition. In some examples, a sinusoidal bias radio signal may be applied. These radio bias signals may be tunable. An estimated average energy of the ions generated in the plasma sheath (i.e., a portion of plasma having greater density of positive ions) may provide information about the shape and amplitude of the bias signal.

In some aspects, the polycarbonate substrate may be configured to receive at least a first radio signal bias. The substrate bias may be used to control the energy of ions impinging the polycarbonate substrate. Further, the incorporation of an additional substrate bias may increase the density of atomic oxygen present in the process gas. The increase in the density of the oxygen may alter properties of the deposited layers of the composite material. For example, the layers themselves may become more dense and less porous for a given set of bias conditions.

In further aspects, the layers described herein may be deposited at the polycarbonate substrate by a pulsed plasma. In the pulsed PECVD process, the frequency of the plasma source may be pulsed, that is, a high frequency radio frequency may be turned off and on. Characteristics of the pulse may be varied by changing the pulse repetition frequency (frequency of turning a high frequency plasma source power on) and duty cycle (fraction of time during which a high frequency plasma source power is on). A dual-frequency (MW-RF) plasma source of the present disclosure may include a pulsed radio frequency. Microwave ranges between 300 MHZ-300 GHZ while radio frequencies are between 3 HZ-30 MHZ. According to various aspects of the present disclosure, the plasma may be pulsed during deposition processes with a frequency of 13.56 MHz (or higher harmonics thereof) or a 2.45 GHz MW frequency and a duty cycle lower than 10%. Such an adjustment to the plasma pulse may reduce heat loading on the polycarbonate substrate and may ensure a homogenous rate of deposition during the process. Adjustments to the microwave power enable control of the ion production during plasma pulse.

Plasma may be generated from the inert precursor process gas or the precursor process gas using a microwave radiation or power source. The microwave power source may be configured to an antenna-like structure (herein, an antenna) used to direct the process gas. Plasma forms as the process gas is applied and exposed to the microwave radiation through the antenna. Because of the high electrical conductivity of the plasma, the antenna may form a coaxial wave-guide. Microwaves may propagate along the formed wave-guide and plasma may be generated along the complete length of the antenna. As such, the length of the antenna may determine the length of the generated plasma. The antenna may comprise any conducting material. In an example, the antenna comprises a copper tube having an interior and exterior quartz coating.

More specifically, microwave radiation is applied to the antenna and as a process gas is flowing therethrough, a coaxial wave-guide is formed at the quartz interior of the antenna. The coaxial wave-guide formed in the interior of the tube allows for microwaves to propagate along the tube and for plasma to form along the length of the quartz exterior coating.

One or more layers deposited at the polycarbonate substrate may comprise an adhesion-promoting layer. The adhesion-promoting layer refers to a layer of deposited plasma in the solid-state (derived from the process gas) that promotes or facilitates the successive addition of layers. Certain properties of the adhesion-promoting layer enable the layer to promote the addition of a successive layer. In a specific example, the adhesion-promoting layer may be carbon rich. The adhesion-promoting layer may be deposited directly to the treated polycarbonate substrate to facilitate the deposition of a successive solid-state layer formed from the precursor gas. In some aspects, the adhesion-promoting layer may be thin, that is, thin compared to the barrier layers which may be between about 10 nanometers (nm) and 1000 nm. For example, the adhesion-promoting layer may be about 1 nm in thickness.

The one or more layers deposited at the polycarbonate substrate may exhibit different functionalities. In one example, a deposited layer succeeding the adhesion-promoting layer may be described as a “barrier layer.” A barrier layer may impart the polycarbonate substrate with diffusion barrier properties to provide the composite material described herein. The barrier layer may resist gas permeation through the composite material. A measure of the barrier performance of the composite material may be the gas permeation rate of the composite, or of a finished package comprising the composite. For example, an oxygen permeation rate or a moisture permeation rate may be obtained. Commercially available laminate food packaging (i.e., retortable packaging) are desired to have an oxygen transmission rate below 2 cm³/m²·day·bar (cubic centimeter per square meter per day per bar). A barrier layer as described herein may be between about 10 nanometers (nm) to about 1000 nm depending upon the intended use of the film.

In various examples disclosed herein, the composite material may be formed as one or more layers and may be applied to the surface of a polycarbonate substrate via plasma-enhanced chemical vapor deposition. The surface of the polycarbonate substrate may be bombarded with an inert precursor process gas flowing from a gas supply and into a deposition chamber through the tubing of an antenna. A first inert gas, such as argon or nitrogen may be introduced to clean the surface of the polycarbonate substrate. A combination of an inert gas and an excitation gas may be applied. Thus, the inert precursor process gas may comprise a mixture of inert gas and an excitation gas such as oxygen or nitrogen. The mixture may comprise argon/oxygen or argon/nitrogen, for example.

As microwave and radiofrequencies are applied, the inert gas mixture forms a plasma to pre-treat the surface of the polycarbonate substrate. The plasma formed from the inert gas mixture may remove any surface contaminants and may activate functional groups of the surface of the polycarbonate substrate. Activation of these groups primes the surface of the substrate to receive one or more solid-state layers. A process gas may be directed from the gas supply into the deposition chamber and through the tubing of the antenna. The process gas forms a process plasma as microwave and radio frequencies are applied. The process plasma may be deposited as a first layer at the surface of the polycarbonate substrate. The first layer may comprise a carbon rich promoting layer to facilitate adhesion of succeeding layers. One or more succeeding layers may grow at the promoting layer to provide the composite material.

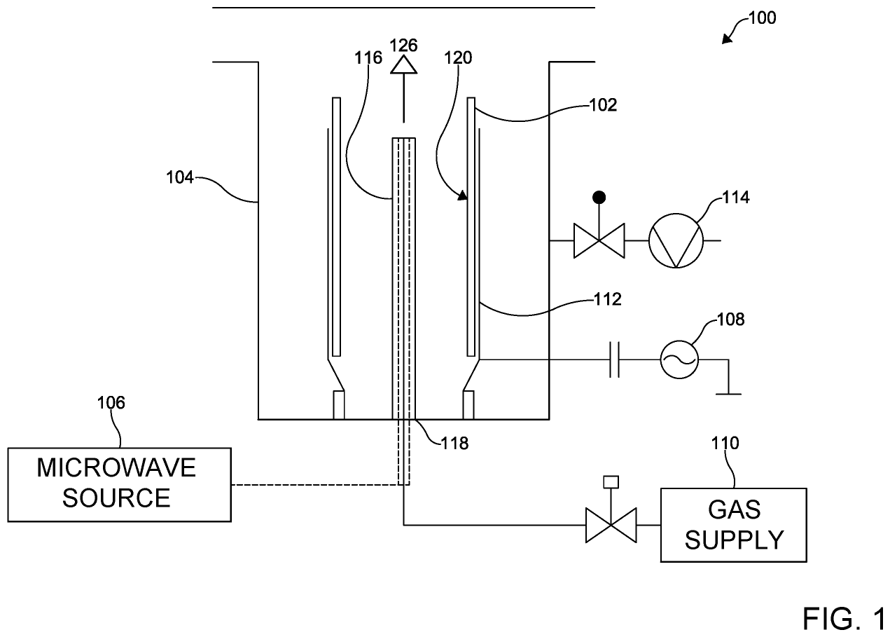

As described herein, FIG. 1 illustrates a schematic diagram of a plasma-enhanced chemical deposition system 100 that may be used to apply one or more layers to a polycarbonate substrate 102. The plasma-enhanced chemical deposition system 100 may include a deposition chamber 104 configured to a microwave power source 106, a radio frequency bias 108, and a gas supply 110.

In an aspect, the polycarbonate substrate 102 may be disposed within the deposition chamber 104. The polycarbonate substrate 102 may be stationary inside the deposition chamber 104 or it may be able to rotate. In an example, the polycarbonate substrate 102 may be positioned in a substrate holder 112 within the deposition chamber 104. The deposition chamber 104 may comprise any appropriate vessel of a size and shape to accommodate the polycarbonate substrate 102 and substrate holder 112. A vacuum atmosphere or low-pressure conditions may be maintained in the deposition chamber 104. The deposition chamber 104 may be configured to a vacuum pump 114 to provide a low pressure or vacuum environment therein. Low pressure may refer to a pressure within the deposition chamber 104 that allows for the application of film layers to the polycarbonate substrate 102. For example, pressure inside the deposition chamber 104 may be maintained between about 1×10⁻⁴ Pascals (Pa) and about 10 Pa.

The microwave power source 106 may be used to deliver microwave energy into the deposition chamber 104. The microwave power source 106 may deliver microwave energy into the deposition chamber 104 via coupling to an antenna 116 that extends from an inlet 118 of the deposition chamber 104 and into the interior of the deposition chamber 104. In one example, the microwave power source 106 may convey microwave radiation at a frequency of about 2.45 GHz and a power of up to about 2 kW (kilowatts) to the deposition chamber 104.

To enable layer deposition at a surface 120 of the polycarbonate substrate 102, the antenna 116 may be configured to the inlet 118 of the deposition chamber to allow passage therethrough. The antenna 116 may be positioned in the deposition chamber 104 such that the antenna 116 is adjacent the surface 120 of the polycarbonate substrate 102 at which layers will be deposited. The polycarbonate substrate 102 may be positioned in deposition chamber 104 so that a surface 120 of the substrate 102 is oriented towards the antenna 116. The polycarbonate substrate 102 may be supported and held in place in the deposition chamber by the 112 substrate holder. In one example, the substrate may be a film held in place in the substrate holder by a portion of adhesive, such as an adhesive tape. The substrate holder may also comprise a roll-to-roll apparatus where the substrate comprises a film. In further examples, where the substrate may comprise a three-dimensional object such as a vessel or bottle, the substrate holder comprises an apparatus configured to maintain the position of the substrate.

The substrate holder 112 may orient the polycarbonate substrate 102 for the deposition of a solid-state layer as plasma is generated in the deposition chamber 104. Further, the substrate holder 112 may convey the desired radio frequency to the deposition chamber 104 and to the polycarbonate substrate 102. In various examples, the substrate holder 112 thus may be configured to the radio frequency bias 108. In one example, as provided in FIG. 1, the substrate holder 112 may be configured to the radio frequency bias 108 to deliver a tunable sinusoidal signal of 13.56 MHz to the polycarbonate substrate.

As a process gas (or a precursor process gas) is delivered to the deposition chamber 104 and radio and microwave frequencies are applied, plasma may be generated. To deliver the process gas to the deposition chamber 104, the inlet 118 of the deposition chamber may be in fluid communication with the gas supply 110. To provide the process gas to the antenna 116 for the generation of the plasma, the inlet 118 may be in fluid communication with the antenna 116. In some examples, the antenna 116 may comprise a cylindrical tube to allow the passage of fluid therethrough. As such, the gas supply 110 may be in fluid communication with the antenna 116 via the inlet 118 of the deposition chamber 104. The tubular antenna 116 may be configured to provide a process gas or a precursor process gas 126 from the gas supply 110 and into the deposition chamber 104.

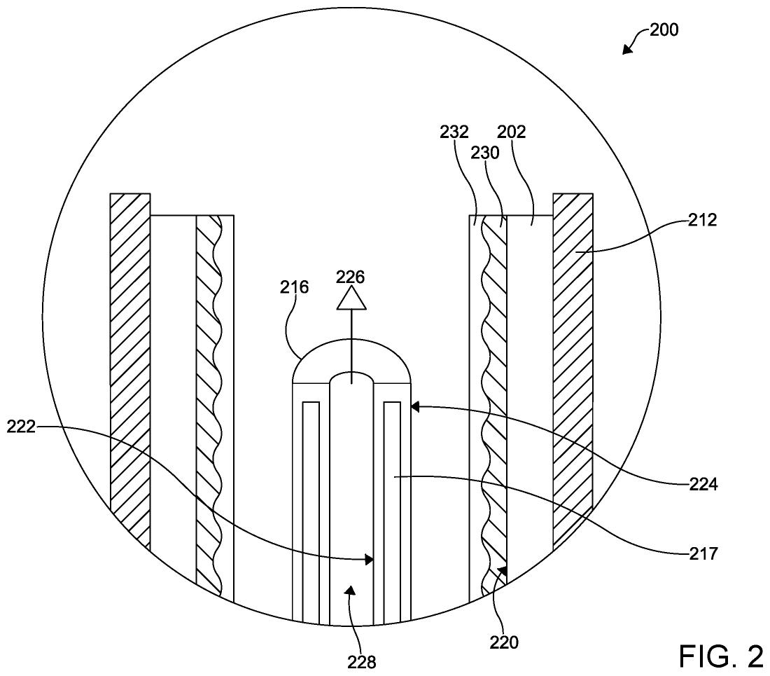

As shown in the enlarged diagram in FIG. 2, the antenna 216 of the deposition device 200 may comprise a cylindrical tube structure. In a specific example as shown in FIG. 2, the antenna 216 may comprise a copper tube 217. The copper tube 217 may have a quartz coating providing an interior quartz surface 222 and an exterior quartz surface 224. The exterior quartz surface 224 may be oriented towards the surface 220 of the polycarbonate substrate 202.

Referring to FIG. 1, a process gas 126 may be caused to flow through the antenna 116 as microwave radiation is delivered to the antenna 116 and a radio frequency is pulsed to the substrate holder 112 and to the polycarbonate substrate 102. The applied energies generate a plasma from the flowing process gas 126.

As illustrated in FIG. 2, the interior 228 of the copper tube 217 may provide a coaxial wave guide therethrough allowing the plasma to form along the exterior quartz surface 224 of the copper tube. As an example, the polycarbonate substrate 202 may be pre-treated with plasma of a precursor process gas where the process gas 226 is an inert gas mixture (combination of inert gas and excitation gas). The pre-treatment may remove contaminants from and activate functional groups at the surface 220 as the polycarbonate substrate 202 is supported in the substrate holder 212.

In some examples, the generated plasma deposits as a first layer 230 on the treated surface 220 of the polycarbonate substrate 202 where the process gas 226 comprises an organosilicon compound. The deposited first layer 230 may comprise a rich adhesion-promoting layer. The adhesion-promoting layer may be about 1 nm in thickness. As plasma continues to be formed, monomer growth continues on the adhesion-promoting first layer 230 until the SiOₓ barrier layer, and subsequent layers 232 are formed.

In various examples disclosed herein, methods and devices are disclosed for forming one or more layers on a polycarbonate substrate. In an example, a polycarbonate substrate is disposed in a deposition chamber maintained under vacuum pressure that allows for the deposition of one or more plasma coating layers on the polycarbonate substrate. The polycarbonate substrate may be configured to a tunable sinusoidal bias. A microwave power source, such as a genitor, may feed microwave radiation through a tubular antenna adjacent the polycarbonate substrate. As the radio signal and microwave radiation are applied and as a precursor process gas flows through the antenna, plasma may be generated along the antenna exterior. The polycarbonate substrate may be treated with an inert precursor process gas to remove contaminants and activate the substrate surface. As a process gas comprising an organosilicon compound, for example, is applied, deposition of a solid-state film occurs at the surface of the treated polycarbonate substrate and a heterogeneous layer grows. The process may be used to apply layers continuously at the polycarbonate substrate to impart the substrate with improved barrier properties.

Composite materials comprising the layered polycarbonate substrate exhibit improved resistance to gas permeability and better surface properties when comparable to a non-coated polycarbonate substrate. A composite material formed through MW-RF PECVD on a polycarbonate substrate may exhibit improved barrier properties. The composite material may exhibit an oxygen transmission rate (OTR) from between about 10⁻⁶ cubic centimeters per square meter per day per bar (cm³/m²·day·bar) to less than about 1 cm³/m²·day·bar when tested in accordance with ISO 15105-2. In one aspect the composite material may exhibit an OTR of between about 10⁻² cm³/m²·day·bar and about 1 cm³/m²·day·bar when measured in accordance with ISO 15105-2. In another aspect in which the processes described herein are combined with an atomic layer deposition process (described below), the composite material may exhibit an OTR between about 10⁻⁶ cm³/m²·day·bar and about 10⁻² cm³/m²·day·bar when measured in accordance with ISO 15105-2. In specific aspects the composite material may exhibit an OTR of less than about 0.8 cm³/m²·day·bar, or of about 0.7 cm³/m²·day·bar. In further examples, the composite material exhibits an oxygen transmission rate less than that of substantially similar non-coated substrate. In further examples, the composite exhibits an oxygen transmission rate less than that of a substantially similar composite material formed by a low radio frequency plasma-enhanced chemical vapor deposition process (LRF PECVD).

In certain aspects, an atomic layer deposition (ALD) processes may be combined with the processes of MW-RF PECVD described herein to provide a composite exhibiting a further enhanced barrier performance. For example, an enhanced barrier performance may refer to an OTR at the lower limit of the range of 10⁻⁶ cm²/m²·day·bar to less than about 1 cm²/m²·day·bar when tested in accordance with ISO 15105-2. An ALD process refers to a thin film deposition technique based on sequential, self-limiting and surface controlled gas phase chemical reactions which provide control of film growth at a substrate surface in nanometer and sub-nanometer ranges. As such, an ALD process may be used in conjunction with the MW-RF PECVD methods provided herein to achieve layers at the polycarbonate substrate that provide a barrier performance at 10⁻⁶ cm³/m²·day·bar.

In a specific example, the composite material may exhibit an OTR of less than about 1 cm³/m²·day·bar. A substantially similar non-coated polycarbonate substrate may exhibit an OTR of about 1000±1.94 cm³/m²·day·bar. A substantially similar composite material formed by a LRF PECVD may have an OTR of about 63.4 cm³/m²·day·bar. A substantially similar non-coated polycarbonate substrate may refer to a polycarbonate substrate comprising the same or similar polycarbonate substrate as the composite material except that a barrier layer has not been disposed adjacent a surface of the polycarbonate substrate. A substantially similar composite material formed by a LRF-PECVD may refer to a composite material formed from the same or similar polycarbonate substrate, but upon which layers have been applied according to an alternative PECVD process, specifically, a low radio frequency (LRF) PECVD process where the radio frequency applied in the plasma deposition is at about 400 kHz, or a range of 3 Hz to about 3 MHz. Thus, the composite material of the present disclosure prepared using MW-RF PECVD may exhibit an OTR less than that of a composite material formed using LRF-PECVD.

The composite material disclosed herein may exhibit a greater barrier improvement factor (BIF) compared to that observed for a LRF-PECVD composite. The barrier improvement factor may be expressed according to the following formula:

$$BIF = \frac{OTR ( non \text{-} coated PC )}{OTR ( coated PC )}$$

As a specific example, the composite material of the present disclosure may exhibit a barrier of greater than 1000. The composite material of the present disclosure may exhibit a BIF of from about 500 to about 10⁸. A substantially similar LRF-PECVD composite material may exhibit a BIF value of less than 50.

In some aspects, the composite materials disclosed herein may maintain the surface properties attributed to a non-coated polycarbonate substrate, even after more rigorous processing conditions such as heat and chemical exposure. The disclosed composite material may maintain surface and structural properties (including the OTR) after being subjected to temperatures in excess of 110° C. (such as during autoclaving). Further, as polycarbonate materials are well known for their transparency, the composite material may maintain surface transparency and resist hazing when exposed to caustic or typically damaging organic solvents such as acetone.

In particular aspects, the film exhibits a transmission of greater than about 88% at a 2.5 mm, or at about 2.5 mm, film thickness. In certain aspects, the film exhibits a transmission of greater than about 90% at less than 1 mm film thickness or less than about 1 mm film thickness. The film may also have a haze of less than 1%, or in some aspects less than 0.6%, or from about 0.01% to about 1.0%, or from about 0.01% to about 0.6%.

In further aspects, surface roughness of the disclosed MW-RF PECVD composite material may be comparable to the surface roughness of a substantially similar non-coated polycarbonate material. A non-coated polycarbonate may exhibit a surface roughness between about 0.2 nm and about 0.8 nm. As provided herein, the composite disclosed herein may exhibit a smooth roughness (surface roughness) less than about 5 nm, or between about 1 nm and 5 nm. Comparatively, a LRF composite may exhibit a surface roughness of greater than about 10 nm, as provided in Example 2 disclosed herein.

The advantageous characteristics of the composite materials and films disclosed herein may make them appropriate for an array of uses. The materials disclosed herein may be used in articles and devices in packaging, automotive, electronics, life sciences, and energy related fields. Given their improved diffusion barrier properties, articles formed from the composite materials may be particularly useful in packaging applications for food, cosmetics, and pharmaceuticals as described herein.

The composite materials may be used to manufacture articles for use in electronic, automotive, or imaging, applications for example. Devices and applications may include: anti-fog windows; lenses and/or transparent covers for lighting applications such as automotive lighting including headlights, street lighting, outdoor lighting, and high efficiency lighting such as light emitting diode LED applications, organic LED applications, electro-devices which may include optical electronic devices such as cathode ray tubes, fluorescent lighting, vapor gas discharge light sources, and neon light, as well as light emitting diodes, organic light emitting diodes, plasma, and liquid crystal screens.

Electronic-related articles formed from the composite materials and films may include, but are not limited to, parts and components of personal computers, notebook and portable computers, cell phone antennas and other such communications equipment, medical applications, RFID applications, automotive applications, and the like. In various further aspects, the articles may be appropriate as a computer and business machine housings such as a housing for laptop personal computers, monitors, robotics, hand held electronic device housing (such as a housing or flash holder for smart phones, tablets, music devices), electrical connectors, LED heat sink, and components of lighting fixtures, wearables, ornaments, home appliances, and the like. Other non-limiting examples of fields in which the materials may be employed can include electrical, electro-mechanical, radio frequency (RF) technology, telecommunication, automotive, aviation, medical, sensor, military, and security. The composite materials and films may also be present in overlapping fields, such as mechatronic systems that integrate mechanical and electrical properties which can, for example, be used in automotive or medical engineering.

In a further aspect, the molded articles can be used to manufacture devices in the automotive field. Non-limiting examples of such devices in the automotive field which may include the disclosed materials in a vehicle's interior include adaptive cruise control, headlight sensors, windshield wiper sensors, and door/window switches. Non-limiting examples of devices in a vehicle's exterior may include pressure and flow sensors for engine management, air conditioning, crash detection, and exterior lighting fixtures.

In further examples, the materials may be used in imaging or optical applications. Such applications may include, but are not limited to: lenses and/or transparent covers for lighting applications such as automotive lighting, street lighting, outdoor lighting, and high efficiency lighting such as light emitting diode LED applications, organic LED applications, fluorescent lighting applications, vapor gas discharge lighting applications, and neon light applications, which may produce less heat as a byproduct compared to conventional light sources; optical lenses including camera and viewing lenses (e.g., for mobile telephone cameras and for digital still photography cameras), mirrors, telescopic lenses, binoculars, automotive camera lenses, and ophthalmic items such as eyewear including sunglasses, protective goggles, face shields, and prescription lenses. The materials may also be useful in optoelectronic devices such as solar cells which are particularly difficult to protect with a polymer material due to the very harsh conditions in which they operate.

The composite materials and films disclosed herein may be useful in biomedical and life science applications. For example, but not to be limiting, the films may be used as coating or therapeutic coatings for implantable medical devices, implantable ophthalmic lenses, medical/surgical instruments, among others.

As provided herein, the composite materials and films formed herein may exhibit an OTR 10⁻⁶ cm²/m²·day·bar to less than about 1 cm³/m²·day·bar. In one aspect, a film of the present disclosure may exhibit an OTR of from about 10⁻² cm²/m²·day·bar to about 1 cm²/m²·day·bar and thus may be suitable for use in packaging such as food, pharmaceutical and cosmetic packaging. In further aspects, a film of the present disclosure may exhibit an OTR of from about 10⁻⁶ cm²/m²·day·bar to about 10⁻² cm²/m²·day·bar and may be suitable for use in electronics and microelectronics. These electronics and microelectronics may include, for example, light emitting diode (LED) applications; organic LED applications; electro-devices which may further include optical electronic devices such as cathode ray tubes, fluorescent lighting, vapor gas discharge light sources, and neon light, as well as light emitting diodes, organic light emitting diodes, plasma, and liquid crystal screens.

Furthermore, articles and products made from the disclosed compositions may be also be used in a variety of applications including thin-wall articles, where transparency, precision as defined by a high degree of reproducibility, retention of mechanical properties including impact strength, and precise optical properties are required. In a specific example, optically transparent, melt polycarbonate films may be weatherable, or resistant to outdoor weathering conditions of higher heat and full sun conditions. The articles may be used to protect optoelectronic devices, such as solar cells, situated in outdoor working environments for extended periods of time while maintaining impact strength and optical properties.

Various combinations of elements of this disclosure are encompassed by this disclosure, e.g. combinations of elements from dependent claims that depend upon the same independent claim.

### Definitions

It is also to be understood that the terminology used herein is for the purpose of describing particular aspects only and is not intended to be limiting. As used in the specification and in the claims, the term “comprising” can include the aspects “consisting of” and “consisting essentially of” Unless defined otherwise, all technical and scientific terms used herein have the same meaning as commonly understood by one of ordinary skill in the art to which this disclosure belongs. In this specification and in the claims which follow, reference will be made to a number of terms which shall be defined herein.

As used in the specification and the appended claims, the singular forms “a,” “an” and “the” include plural referents unless the context clearly dictates otherwise. Thus, for example, reference to “a polycarbonate polymer” includes mixtures of two or more polycarbonate polymers.

As used herein, the term “combination” is inclusive of blends, mixtures, alloys, reaction products, and the like.

Ranges can be expressed herein as from one value (first value) to another value (second value). When such a range is expressed, the range includes in some aspects one or both of the first value and the second value. Similarly, when values are expressed as approximations, by use of the antecedent ‘about,’ it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “about” and “at or about” mean that the amount or value in question can be the designated value, approximately the designated value, or about the same as the designated value. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

As used herein, the terms “optional” or “optionally” means that the subsequently described event or circumstance can or cannot occur, and that the description includes instances where said event or circumstance occurs and instances where it does not. For example, the phrase “optionally substituted alkyl” means that the alkyl group can or cannot be substituted and that the description includes both substituted and unsubstituted alkyl groups.

As used herein, the term “effective amount” refers to an amount that is sufficient to achieve the desired modification of a physical property of the composition or material. For example, an “effective amount” of a filler refers to an amount that is sufficient to achieve the desired improvement in the property modulated by the formulation component, e.g. achieving the desired level of modulus. The specific level in terms of wt. % in a composition required as an effective amount will depend upon a variety of factors including the amount and type of polycarbonate, amount and type of polycarbonate, amount and type of thermally conductive filler, and end use of the article made using the composition.

Disclosed are the components to be used to prepare the compositions of the disclosure as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds cannot be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the disclosure. Thus, if there are a variety of additional steps that can be performed it is understood that each of these additional steps can be performed with any specific aspect or combination of aspects of the methods of the disclosure.

References in the specification and concluding claims to parts by weight of a particular element or component in a composition or article, denotes the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

As used herein the terms “weight percent,” “wt %,” and “wt. %,” which can be used interchangeably, indicate the percent by weight of a given component based on the total weight of the composition, unless otherwise specified. That is, unless otherwise specified, all wt. % values are based on the total weight of the composition. It should be understood that the sum of wt. % values for all components in a disclosed composition or formulation are equal to 100.

Compounds are described using standard nomenclature. For example, any position not substituted by any indicated group is understood to have its valence filled by a bond as indicated, or a hydrogen atom. A dash (“-”) that is not between two letters or symbols is used to indicate a point of attachment for a substituent. For example, —CHO is attached through carbon of the carbonyl group. Unless defined otherwise, technical and scientific terms used herein have the same meaning as is commonly understood by one of skill in the art to which this disclosure belongs.

As used herein, “polycarbonate” refers to an oligomer or polymer comprising residues of one or more dihydroxy compounds, e.g., dihydroxy aromatic compounds, joined by carbonate linkages; it also encompasses homopolycarbonates, copolycarbonates, and (co)polyester carbonates.

As used herein “radical,” refers to a fragment, group, or substructure of a molecule described herein, regardless of how the molecule is prepared. For example, a hexamethyldisiloxane radical in a particular compound may have a structure:

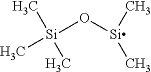

“Organic radicals,” as the term is defined and used herein, contain one or more carbon atoms. An organic radical can have, for example, 1-26 carbon atoms, 1-18 carbon atoms, 1-12 carbon atoms, 1-8 carbon atoms, 1-6 carbon atoms, or 1-4 carbon atoms. In a further aspect, an organic radical can have 2-26 carbon atoms, 2-18 carbon atoms, 2-12 carbon atoms, 2-8 carbon atoms, 2-6 carbon atoms, or 2-4 carbon atoms. Organic radicals often have hydrogen bound to at least some of the carbon atoms of the organic radical. One example, of an organic radical that comprises no inorganic atoms is a 5,6,7,8-tetrahydro-2-naphthyl radical. In some aspects, an organic radical can contain 1-10 inorganic heteroatoms bound thereto or therein, including halogens, oxygen, sulfur, nitrogen, phosphorus, and the like. Examples of organic radicals include but are not limited to an alkyl, substituted alkyl, cycloalkyl, substituted cycloalkyl, mono-substituted amino, di-substituted amino, acyloxy, cyano, carboxy, carboalkoxy, alkylcarboxamide, substituted alkylcarboxamide, dialkylcarboxamide, substituted dialkylcarboxamide, alkylsulfonyl, alkylsulfinyl, thioalkyl, thiohaloalkyl, alkoxy, substituted alkoxy, haloalkyl, haloalkoxy, aryl, substituted aryl, heteroaryl, heterocyclic, or substituted heterocyclic radicals, wherein the terms are defined elsewhere herein. A few non-limiting examples of organic radicals that include heteroatoms include alkoxy radicals, trifluoromethoxy radicals, acetoxy radicals, dimethylamino radicals and the like.

As used herein, the terms “number average molecular weight” or “Mₙ” can be used interchangeably, and refer to the statistical average molecular weight of all the polymer chains in the sample and is defined by the formula:

$${M}_{n} = \frac{Σ {N}_{i} {M}_{i}}{Σ {N}_{i}} ,$$

where Mᵢ is the molecular weight of a chain and Nᵢ is the number of chains of that molecular weight. Mₙ can be determined for polymers, e.g., polycarbonate polymers, by methods well known to a person having ordinary skill in the art using molecular weight standards, e.g. polycarbonate standards or polystyrene standards, preferably certified or traceable molecular weight standards.

As used herein, the terms “weight average molecular weight” or “Mw” can be used interchangeably, and are defined by the formula:

$${M}_{w} = \frac{Σ {N}_{i} {M}_{i}^{2}}{Σ {N}_{i} {M}_{i}} ,$$

where Mᵢ is the molecular weight of a chain and Nᵢ is the number of chains of that molecular weight. Compared to Mₙ, M_{w} takes into account the molecular weight of a given chain in determining contributions to the molecular weight average. Thus, the greater the molecular weight of a given chain, the more the chain contributes to the M_{w}. M_{w} can be determined for polymers, e.g. polycarbonate polymers, by methods well known to a person having ordinary skill in the art using molecular weight standards, e.g. polycarbonate standards or polystyrene standards, preferably certified or traceable molecular weight standards.

The terms “residues” and “structural units”, used in reference to the constituents of the polymers, are synonymous throughout the specification.

Each of the materials disclosed herein are either commercially available and/or the methods for the production thereof are known to those of skill in the art.

It is understood that the compositions disclosed herein have certain functions. Disclosed herein are certain structural requirements for performing the disclosed functions, and it is understood that there are a variety of structures that can perform the same function that are related to the disclosed structures, and that these structures will typically achieve the same result.

In various aspects, the present disclosure pertains to and includes at least the following aspects.

Aspect 1A. A film formed by a process of plasma-enhanced chemical vapor deposition, the process comprising: applying a radio frequency bias to a substrate; supplying a process gas through an antennae, where microwave power applied to the antennae generates plasma of the process gas at the surface of the substrate thereby forming one or more layers on the substrate; wherein the composite material has an oxygen transmission rate of between about 10⁻⁶ cm³/m²·day·bar to less than about 1 cm³/m²·day·bar when measured in accordance with ISO 15105-2, wherein the film exhibits a barrier improvement factor of greater than 1000 when compared to a substantially similar substrate; wherein the film exhibits a transmission of greater than about 88% at a 2.5 mm, or at about 2.5 mm, film thickness; and; and wherein the film exhibits a surface roughness substantially similar to the surface roughness of a substantially similar substrate; wherein the film exhibits chemical resistance to organic solvents; and wherein the film a surface roughness of less than about 2 nm.

Aspect 1B. A film formed by a process of plasma-enhanced chemical vapor deposition, the process consisting of: applying a radio frequency bias to a substrate; supplying a process gas through an antennae, where microwave power applied to the antennae generates plasma of the process gas at the surface of the substrate thereby forming one or more layers on the substrate; wherein the composite material has an oxygen transmission rate of between about 10⁻⁶ cm³/m²·day·bar to less than about 1 cm³/m²·day·bar when measured in accordance with ISO 15105-2, wherein the film exhibits a barrier improvement factor of greater than 1000 when compared to a substantially similar substrate; wherein the film exhibits a transmission of greater than about 88% at a 2.5 mm film thickness, or at about 2.5 mm film thickness; and; and wherein the film exhibits a surface roughness substantially similar to the surface roughness of a substantially similar substrate; wherein the film exhibits chemical resistance to organic solvents; and wherein the film a surface roughness of less than about 2 nm.

Aspect 1C. A film formed by a process of plasma-enhanced chemical vapor deposition, the process consisting essentially of: applying a radio frequency bias to a substrate; supplying a process gas through an antennae, where microwave power applied to the antennae generates plasma of the process gas at the surface of the substrate thereby forming one or more layers on the substrate; wherein the composite material has an oxygen transmission rate of between about 10⁻⁶ cm³/m²·day·bar to less than about 1 cm³/m²·day·bar when measured in accordance with ISO 15105-2, wherein the film exhibits a barrier improvement factor of greater than 1000 when compared to a substantially similar substrate; wherein the film exhibits a transmission of greater than about 88% at a 2.5 mm, or at about 2.5 mm, film thickness; and; and wherein the film exhibits a surface roughness substantially similar to the surface roughness of a substantially similar substrate; wherein the film exhibits chemical resistance to organic solvents; and wherein the film a surface roughness of less than about 2 nm.

Aspect 2. The film of any of aspects 1A-1C, wherein the substrate comprises a thermoplastic polymer.

Aspect 3A. A film formed by a process of plasma-enhanced chemical vapor deposition, the process comprising: applying a radio frequency bias to a polycarbonate substrate; supplying a process gas through an antennae, where microwave power applied to the antennae generates plasma of the process gas at the surface of the polycarbonate substrate thereby forming one or more layers on the polycarbonate substrate; wherein the film has an oxygen transmission rate of between about 10⁻⁶ cm³/m²·day·bar to less than about 1 cm³/m²·day·bar when measured in accordance with ISO 15105-2; and wherein the film exhibits a transmission of greater than about 88% at a 2.5 mm, or at about 2.5 mm, film thickness.

Aspect 3B. A film formed by a process of plasma-enhanced chemical vapor deposition, the process consisting of: applying a radio frequency bias to a polycarbonate substrate; supplying a process gas through an antennae, where microwave power applied to the antennae generates plasma of the process gas at the surface of the polycarbonate substrate thereby forming one or more layers on the polycarbonate substrate; wherein the film has an oxygen transmission rate of between about 10⁻⁶ cm²/m²·day·bar to less than about 1 cm²/m²·day·bar when measured in accordance with ISO 15105-2; and wherein the film exhibits a transmission of greater than about 88% at a 2.5 mm, or at about 2.5 mm, film thickness.

Aspect 3C. A film formed by a process of plasma-enhanced chemical vapor deposition, the process consisting essentially of: applying a radio frequency bias to a polycarbonate substrate; supplying a process gas through an antennae, where microwave power applied to the antennae generates plasma of the process gas at the surface of the polycarbonate substrate thereby forming one or more layers on the polycarbonate substrate; wherein the film has an oxygen transmission rate of between about 10⁻⁶ cm³/m²·day·bar to less than about 1 cm³ /m²·day·bar when measured in accordance with ISO 15105-2; and wherein the film exhibits a transmission of greater than about 88% at a 2.5 mm, or at about 2.5 mm, film thickness.

Aspect 4A. A film formed by a process of plasma-enhanced chemical vapor deposition, the process comprising: applying a radio frequency bias to a polycarbonate substrate; supplying a process gas through an antennae, where microwave power applied to the antennae generates plasma of the process gas at the surface of the polycarbonate substrate thereby forming one or more layers on the polycarbonate substrate; wherein the film has an oxygen transmission rate of between about 10⁻² cm³/m²·day·bar to about 1 cm³/m²·day·bar when measured in accordance with ISO 15105-2; and wherein the film exhibits a transmission of greater than about 88% at a 2.5 mm, or at about 2.5 mm, film thickness.

Aspect 4B. A film formed by a process of plasma-enhanced chemical vapor deposition, the process consisting of: applying a radio frequency bias to a polycarbonate substrate; supplying a process gas through an antennae, where microwave power applied to the antennae generates plasma of the process gas at the surface of the polycarbonate substrate thereby forming one or more layers on the polycarbonate substrate; wherein the film has an oxygen transmission rate of between about 10⁻² cm³/m²·day·bar to about 1 cm³/m²·day·bar when measured in accordance with ISO 15105-2; and wherein the film exhibits a transmission of greater than about 88% at a 2.5 mm, or at about 2.5 mm, film thickness.

Aspect 4C. A film formed by a process of plasma-enhanced chemical vapor deposition, the process consisting essentially of: applying a radio frequency bias to a polycarbonate substrate; supplying a process gas through an antennae, where microwave power applied to the antennae generates plasma of the process gas at the surface of the polycarbonate substrate thereby forming one or more layers on the polycarbonate substrate; wherein the film has an oxygen transmission rate of between about 10⁻² cm³/m²·day·bar to about 1 cm³/m²·day·bar when measured in accordance with ISO 15105-2; and wherein the film exhibits a transmission of greater than about 88% at a 2.5 mm, or at about 2.5 mm, film thickness.

Aspect 5. The film of any of aspects 4A-4C, wherein the film forms packaging that is suitable for one or more of food, pharmaceutical, or cosmetic packaging.

Aspect 6A. A film formed by a process of plasma-enhanced chemical vapor deposition, the process comprising: applying a radio frequency bias to a polycarbonate substrate; supplying a process gas through an antennae, where microwave power applied to the antennae generates plasma of the process gas at the surface of the polycarbonate substrate thereby forming one or more layers on the polycarbonate substrate; wherein the film has an oxygen transmission rate of between about 10⁻³ cm³/m²·day·bar to about 10⁻⁶ cm³/m²·day·bar when measured in accordance with ISO 15105-2; and wherein the film exhibits a transmission of greater than about 88% at a 2.5 mm, or at about 2.5 mm, film thickness.

Aspect 6B. A film formed by a process of plasma-enhanced chemical vapor deposition, the process consisting of: applying a radio frequency bias to a polycarbonate substrate; supplying a process gas through an antennae, where microwave power applied to the antennae generates plasma of the process gas at the surface of the polycarbonate substrate thereby forming one or more layers on the polycarbonate substrate; wherein the film has an oxygen transmission rate of between about 10⁻³ cm³/m²·day·bar to about 10⁻⁶ cm³/m²·day·bar when measured in accordance with ISO 15105-2; and wherein the film exhibits a transmission of greater than about 88% at a 2.5 mm, or at about 2.5 mm, film thickness.

Aspect 6C. A film formed by a process of plasma-enhanced chemical vapor deposition, the process consisting essentially of: applying a radio frequency bias to a polycarbonate substrate; supplying a process gas through an antennae, where microwave power applied to the antennae generates plasma of the process gas at the surface of the polycarbonate substrate thereby forming one or more layers on the polycarbonate substrate; wherein the film has an oxygen transmission rate of between about 10⁻³ cm³/m²·day·bar to about 10⁻⁶ cm³/m²·day·bar when measured in accordance with ISO 15105-2; and wherein the film exhibits a transmission of greater than about 88% at a 2.5 mm, or at about 2.5 mm, film thickness.

Aspect 7. The film of any of aspects 6A-6C, wherein the film is suitable for use in microelectronics such as light emitting diode LED applications, organic LED applications, electro- devices which may include optical electronic devices such as cathode ray tubes, fluorescent lighting, vapor gas discharge light sources, and neon light, as well as light emitting diodes, organic light emitting diodes, plasma, and liquid crystal screens.

Aspect 8. The film of any of aspects 3-7, the process further comprising causing an inert gas to activate a surface of the substrate prior to deposition of the one or more layers on the polycarbonate substrate.

Aspect 9. The film of any of aspects 3-8, wherein the film exhibits a barrier improvement factor of greater than 1000 when compared to a substantially similar polycarbonate substrate.

Aspect 10. The film of any of aspects 3-9, wherein the film exhibits a surface roughness substantially similar to the surface roughness of a substantially similar polycarbonate substrate.

Aspect 11. The film of any of aspects 3-10, wherein the film exhibits a surface roughness of less than about 2 nm.

Aspect 12. The film of any of aspects 3-11, wherein the polycarbonate substrate is maintained at a temperature less than the glass transition temperature of the polycarbonate.

Aspect 13. The film of any of aspects 3-12, wherein the polycarbonate substrate comprises a thin film.

Aspect 14. The film any of aspects 3-12, wherein the polycarbonate substrate comprises a three-dimensional structure, a sheet, or any combination thereof.

Aspect 15. The film of any of aspects 1A-14, wherein a layer of the one or more layers comprises an adhesion-promoting layer to facilitate adhesion of a successive layer.

Aspect 16. The film of any of aspects 1A-15, wherein the antennae comprises a copper tube.

Aspect 17. The film of any of aspects 1A-16, wherein the antennae comprises a copper tube having an interior quartz coating and an exterior quartz coating.

Aspect 18. The film of any of aspects 1A-17, wherein the microwave power generates a coaxial wave guide at the tube.

Aspect 19. The film of any of aspects 1A-18, wherein the process gas comprises at least an organosilicon compound.

Aspect 20. The film of any of aspects 1A-19, wherein the process gas comprises at least hexamethyldisiloxane.

Aspect 21. The film of any of aspects 1A-20, wherein the microwave power is applied at a frequency of 2.45 GHz.

Aspect 22. The film of any of aspects 1A-21, wherein the microwave power is provided at a power of up to about 2 kilowatts.

Aspect 23. The film of any of aspects 1A-22, wherein the radio frequency bias signal is at 13.56 MHz.

Aspect 24. The film of any of aspects 1A-23, wherein a layer of the one or more layers comprises a carbon rich adhesion-promoting layer.

Aspect 25. The film of any of aspects 1A-24, wherein the film exhibits a roughness profile having vertical deviations less than that of a substantially similar composite formed from a low radio frequency plasma-enhanced chemical vapor deposition process.

Aspect 26. The film of any of aspects 1A-25, wherein the film has a haze of from about 0.01% to about 0.6%.

Aspect 27. An article formed from the film of any of aspects 1A-26.

Aspect 28A. A method for microwave and radio frequency plasma-enhanced chemical vapor deposition on a substrate, the method comprising: activating a surface of a polycarbonate substrate by treating the surface with an inert gas; generating a dual-frequency plasma of a process gas by causing a radio frequency signal to be applied to the polycarbonate substrate and by causing microwave power to be applied to the process gas at the polycarbonate substrate; and depositing one or more layers adjacent the surface of the polycarbonate substrate to form a film comprising the polycarbonate substrate and the one or more layers; wherein the film exhibits an oxygen transmission rate of between about 10⁻⁶ cm³/m²·day·bar to less than about 1 cm³/m²·day·bar when measured in accordance with ISO 15105-2.

Aspect 28B. A method for microwave and radio frequency plasma-enhanced chemical vapor deposition on a substrate, the method consisting of: activating a surface of a polycarbonate substrate by treating the surface with an inert gas; generating a dual-frequency plasma of a process gas by causing a radio frequency signal to be applied to the polycarbonate substrate and by causing microwave power to be applied to the process gas at the polycarbonate substrate; and depositing one or more layers adjacent the surface of the polycarbonate substrate to form a film comprising the polycarbonate substrate and the one or more layers; wherein the film exhibits an oxygen transmission rate of between about 10⁻⁶ cm³/m²·day·bar to less than about 1 cm³/m²·day·bar when measured in accordance with ISO 15105-2.

Aspect 28C. A method for microwave and radio frequency plasma-enhanced chemical vapor deposition on a substrate, the method consisting essentially of: activating a surface of a polycarbonate substrate by treating the surface with an inert gas; generating a dual-frequency plasma of a process gas by causing a radio frequency signal to be applied to the polycarbonate substrate and by causing microwave power to be applied to the process gas at the polycarbonate substrate; and depositing one or more layers adjacent the surface of the polycarbonate substrate to form a film comprising the polycarbonate substrate and the one or more layers; wherein the film exhibits an oxygen transmission rate of between about 10⁻⁶ cm³/m²·day·bar to less than about 1 cm³/m²·day·bar when measured in accordance with ISO 15105-2.

Aspect 29. The method of any of aspects 28A-28C, wherein the process gas and microwave frequency signal are delivered to the substrate via an antenna, the antennae comprising a tube.

Aspect 30. The method of any of aspects 28A-29, wherein the film exhibits a transmission of greater than about 88% at a 2.5 mm, or at about 2.5 mm, film thickness.

Aspect 31. The method of any of aspects 28A-30, wherein the film has a haze of from about 0.01% to about 0.6%.

Aspect 32A. A method for microwave and radio frequency plasma-enhanced chemical vapor deposition on a polycarbonate substrate, the method comprising: activating a polycarbonate substrate by treating with an inert gas; causing a radio frequency signal to be applied to the polycarbonate substrate; causing a microwave frequency signal to be applied to the polycarbonate substrate via an antennae, the antennae comprising a copper tube; supplying a process gas through the antennae, wherein the microwave frequency signal through the antennae generates plasma of the process gas to effect a chemical vapor deposition of the process gas at the surface of the polycarbonate substrate and form a film.

Aspect 32B. A method for microwave and radio frequency plasma-enhanced chemical vapor deposition on a polycarbonate substrate, the method consisting of: activating a polycarbonate substrate by treating with an inert gas; causing a radio frequency signal to be applied to the polycarbonate substrate; causing a microwave frequency signal to be applied to the polycarbonate substrate via an antennae, the antennae comprising a copper tube; supplying a process gas through the antennae, wherein the microwave frequency signal through the antennae generates plasma of the process gas to effect a chemical vapor deposition of the process gas at the surface of the polycarbonate substrate and form a film.

Aspect 32C. A method for microwave and radio frequency plasma-enhanced chemical vapor deposition on a polycarbonate substrate, the method consisting essentially of: activating a polycarbonate substrate by treating with an inert gas; causing a radio frequency signal to be applied to the polycarbonate substrate; causing a microwave frequency signal to be applied to the polycarbonate substrate via an antennae, the antennae comprising a copper tube; supplying a process gas through the antennae, wherein the microwave frequency signal through the antennae generates plasma of the process gas to effect a chemical vapor deposition of the process gas at the surface of the polycarbonate substrate and form a film.

Aspect 33. The method of any of aspects 32A-32C, further comprising effecting a vacuum atmosphere surrounding the polycarbonate substrate.

Aspect 34A. A film formed by a process of plasma-enhanced chemical vapor deposition, the process comprising: applying a radio frequency bias to a substrate; supplying a process gas through an antennae, where microwave power applied to the antennae generates plasma of the process gas at the surface of the substrate thereby forming one or more layers on the substrate; wherein the composite material has an oxygen transmission rate of between about 10⁻⁶ cm³/m²·day·bar to less than about 1 cm³/m²·day·bar when measured in accordance with ISO 15105-2.

Aspect 34B. A film formed by a process of plasma-enhanced chemical vapor deposition, the process consisting of: applying a radio frequency bias to a substrate; supplying a process gas through an antennae, where microwave power applied to the antennae generates plasma of the process gas at the surface of the substrate thereby forming one or more layers on the substrate; wherein the composite material has an oxygen transmission rate of between about 10⁻⁶ cm³/m²·day·bar to less than about 1 cm³/m²·day·bar when measured in accordance with ISO 15105-2.

Aspect 34C. A film formed by a process of plasma-enhanced chemical vapor deposition, the process consisting essentially of: applying a radio frequency bias to a substrate; supplying a process gas through an antennae, where microwave power applied to the antennae generates plasma of the process gas at the surface of the substrate thereby forming one or more layers on the substrate; wherein the composite material has an oxygen transmission rate of between about 10⁻⁶ cm³/m²·day·bar to less than about 1 cm³/m²·day·bar when measured in accordance with ISO 15105-2.

Aspect 35. The film of any of aspects 34A-34C, wherein the film exhibits a transmission of greater than about 88% at a 2.5 mm, or at about 2.5 mm, film thickness.

Aspect 36. The film of any of aspects 34A-35, wherein the film has a haze of from about 0.01% to about 0.6%.

Aspect 37. The film/method of any of aspects 1A-36, wherein the film has an oxygen transmission rate of between about 10⁻² cm³/m²·day·bar and about 1 cm³/m²·day·bar when measured in accordance with ISO 15105-2.

Aspect 38. The film/method of any of aspects 1A-36, wherein the step of supplying a process gas to form the one or more layers on the substrate to form the film further comprises applying an atomic layer deposition process to the substrate, and wherein the film has an oxygen transmission rate between about 10⁻⁶ cm³/m²·day·bar and about 10⁻² cm³/m²·day·bar when measured in accordance with ISO 15105-2.

### EXAMPLES

The following examples are provided to illustrate the compositions, processes, and properties of the present disclosure. The examples are merely illustrative and are not intended to limit the disclosure to the materials, conditions, or process parameters set forth therein.

Gas tubes of the deposition chamber were heated to prevent condensation of HMDSO. The vacuum system is pumped by a combination of a booster and a roots pump and a gate valve was used to control pressure. A genitor feeds microwave radiation at a frequency of 2.45 GHz and a maximum power of Pcw=2 kW. Plasma is pulsed with a duty cycle lower than 10% to reduce heating load on the substrate and to ensure a homogenous deposition rate along the plasma line. A sinusoidal bias signal at radio frequency of 13.56 MHz (RF) is applied to the substrate holder and the substrate voltage is monitored at the vacuum feedthrough. The applied bias signals are tunable. The information about shape and the amplitude of the bias signal can be facilitated estimating the average energy of ions in the plasma sheath.

Coated samples representing two plasma deposition techniques were prepared. A non-coated polycarbonate substrate was provided as a control. Each coated sample included silica (SiOₓ) coating layers on a polycarbonate substrate. Compact microwave radio frequency plasma-enhanced chemical deposition was performed to provide Sample A. Low radio frequency (LRF) PECVD was performed to provide a Sample B. Optimal process conditions for the MW-PECVD and LRF-PECVD are presented in Table 1 and referred to as reference conditions. Non-coated polycarbonate substrate was designated Sample C.

TABLE 1
Reference conditions of the low RF plasma source
operation mode for PC film deposition.

| Process parameters | LRF Mode | MW-RF Mode |
|---|---|---|
| RF power [Watts, W] | 100 | 2000 |
| Pressure [Pascal, Pa] | 133.3 | 1 |
| O₂:HMDSO | 50 | 50 |
| Deposition time [seconds, s] | 20-30 | >5 |
| Generator | 400 [KHz] | 2.45 [GHz] |
| RF bias signal [Megahertz, MHz] | — | 13.56 |
| Amplitude [volts, V] | — | 36 |
| Chamber temperature [° C.] | 100 | 75 |
| Distance substrate SPI [millimeter, mm] | 16-31 | 30 |

In both plasma deposition technologies, the polycarbonate (PC) film deposition was achieved via a three-step deposition process. First, the polycarbonate substrate was treated with a neat inert gas such as argon, oxygen or nitrogen to clean and active the surface of the polycarbonate. Treatment with inert gas removed surface contamination and generated chemical functional groups at the polycarbonate surface to promote adhesion of the coating layers. In the second step, a thin carbon adhesion-promoting layer was deposited at the polycarbonate surface in a thickness of about 1 nm by the plasma deposition of a hexamethyldisiloxane (HMDSO) process gas. In the third step, the barrier film layer is deposited by growing of monomer on the surface at the carbon adhesion-promoting layer. The substrate temperature was maintained below the glass transition temperature. Thickness of the film layer was adjusted by modifying the deposition time assuming that the deposition rate was constant at each deposition step.

Gas permeation rates for each sample (coated polycarbonate substrate and non-coated polycarbonate substrate) were determined. An oxygen permeation rate was determined according to ISO 15105-2. A critical test area of 12 square centimeters (cm²) was considered and air with 21% oxygen gas was used as test gas. The rates were observed at a temperature of 23° C. and a relative humidity of 50%. The oxygen partial pressure difference used for the permeation measurement by carrier gas method is 1 bar. The permeation rates were obtained for all samples before and after autoclaving.

Total transmittance and transmission haze were evaluated for samples of pure, plasma-coated films before and after acetone in accordance with ASTM D-1003 on a transmission haze guard dual (HGD) instrument (BYK-Gardner, Geretsried, Germany).

To assess heat resistance of coated and non-coated polycarbonate substrates, autoclaving tests were performed. Samples were subjected to temperatures at 121° C., a pressure of 2 bar and a humidity of 100% humidity for 30 minutes to on an autoclave, HTS (3×4×7, Zirbus).

Acetone was administered to the samples to evaluate the chemical resistance of the coated polycarbonate substrates. A discrete volume of acetone was administered on the film and the film observed by the naked eye for visible clouding of the substrate.

Surface morphology investigations were performed using an atomic force microscopy (AFM, Dimension FastScan). The surface morphology of the deposited layers was observed using a microscope for roughness measurements. Roughness measurements were observed in a peak force tapping mode (FastScan A, f=1400 kilohertz (kHz), K=18 Newton per meter (N/m)) at ambient conditions. The height and phase images were recorded simultaneously at the selected location with scanning area of 5×5 square micrometers (μm²) and a scan rate of 5 Hz. Optical imaging integrated in the AFM was used to select a cross-section area of interest for imaging in the AFM. Surface roughness data was obtained using the statistical quantities function in the AFM data analysis program Nanoscope Analysis 1.5. Surface roughness is quantitatively presented as RRms which is the Root Mean Square of a surfaces measured microscopic peaks and valleys.

A scanning electron microscope (ESEM, JSF 7800F, JEOL,) was used to acquire micrographs and thickness of the silica coated layers on the polycarbonate substrate. The scanning electron microscope was operated at an acceleration voltage of 5 kilovolts (kV) on sputter-coated samples (sputter coated with Pd/Pt).

### Example 1

### Compact MW-RF PECVD

The oxygen transmission rate was obtained for coated SiOₓ PC film (Sample A) with barrier performance of 0.70+/−0.13 cm³/m²·day·bar. A ratio for the barrier improvement was obtained after silicon plasma deposition on the polycarbonate substrate. A value of less than 1 for the OTR is indicative of optimal packaging (limited gas permeation). Compact MW-RF PECVD technology samples exhibited OTR values less than 1. A barrier improvement factor (BIF) was calculated according to the formula

$$BIF = \frac{OTR ( bare PC )}{OTR ( coated PC )} .$$

Compact MW-RF PECVD coated polycarbonate substrates exhibited a BIF of 1429.

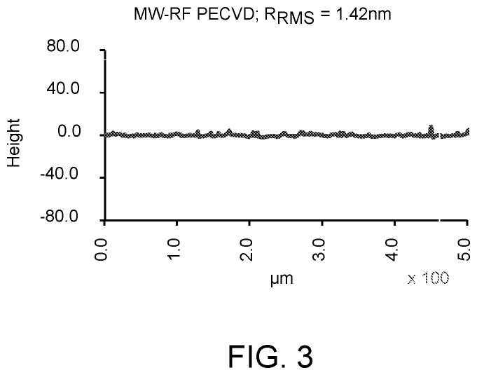

The topography of Sample A showed a homogenous distribution of silica particles throughout the PC substrate. That is, in topography images, portions of the image corresponding to silica particles appeared to be distributed evenly throughout the image area. Larger groups or agglomerations of silica particles were not observed. Sample A also exhibited a smooth roughness of (Ra) 1.42 nm according to AFM results as presented in FIG. 3.

### Comparative Example 2

### LRF-PECVD

The oxygen transmission rate was obtained for coated SiOₓ PC film (Sample B) with barrier performance of 63.4 cm³/m²·day·bar. The ratio for the barrier improvement was obtained after silicon plasma deposition on the polycarbonate substrate. For Sample C, formed according to a LRF-PECVD process, the OTR value was not less than 1, i.e., not indicative of optimal packaging. The BIF was 15. The decline in barrier performance for Sample B may be attributed to the existence of carbon contents and high porosity surface on the deposited film.

The topography of Sample B exhibited different sizes of silica particles and their distribution on the surfaces. That is, silica particle agglomerations varying in size were apparent throughout the images. Darker portions throughout the topography images might correspond to gaps between particles on the coated SiOₓ layers.

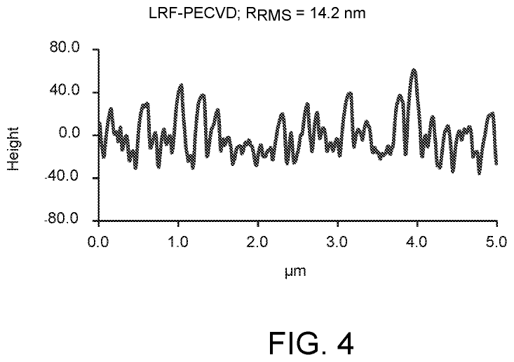

Sample B also showed a large increase in average roughness (Ra) with 14.2 nm observed after plasma SiOₓ coating on the PC substrate. The difference in roughness compared to Samples A and B results can be attributed to changes in surface structures by the decreasing amount of carbon to non-homogeneity silica particles on the film. Sample B also exhibited a smooth roughness of (Ra) 14.2 nm, as shown in FIG. 4.

SEM micrographs of silica coated Sample B showed a spherical shape of deposited SiOₓ particles on the PC substrate. The size distribution of the SiOₓ particles apparent in the SEM micrographs had diameters within the range of 10-70 nm. The particles thus were not uniform. Gaps between the particles lead to high porosity of the surfaces which is in agreement with the AFM results for surface roughness (high value of surface roughness, Rmvis at 14.2 nm). The thickness of coated SiOₓ layer between 50-120 nm was confirmed with SEM image. Three measurements were taken from the SEM image for thickness: 120 nm, 115 nm, and 111 nm, observed at different positions across the layer.

### Comparative Example 3

### Non-Coated Substrate

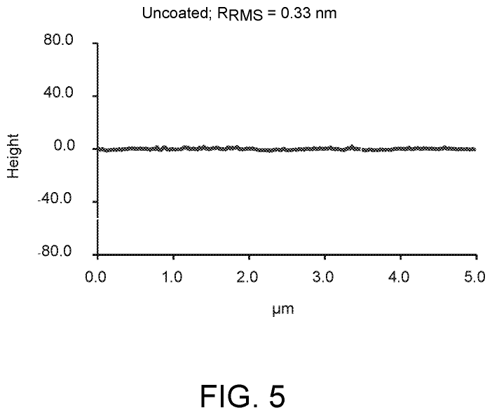

The oxygen transmission rate is obtained for uncoated PC film (Sample C) with barrier performance of 1000+/−1.94 cm³/m²·day·bar. AFM topography measurements of this sample appeared to show a clean surface without any coated layers. A very smooth structure was observed having a roughness (Ra) around 0.33 nm for uncoated PC film, as shown in FIG. 5. The oxygen transmission rate was obtained for a non-coated SiOₓ PC film (Sample C) with barrier performance of 1000+/−1.94 cm³/m²·day·bar. The topography of Sample C showed an unmarked/unblemished surface free of discernible marks and indicated that there were no coated layers. Sample C appeared to have a very smooth surface, which corresponded with the roughness (Ra) at about 0.33 nm observed using AFM as shown in FIG. 5.

The forgoing values for OTR and BIF for the two plasma technologies (LRF-PECVD and Compact MW-RF PECVD) are summarized in Table 2.

TABLE 2
Barrier performance for PECVD coated and non-coated substrates.

| | OTR | |
|---|---|---|
| Material | (cm³m⁻²d⁻¹bar⁻¹) | BIF |
| PC | 1000 | NA |
| PC coated by LRF PECVD | 64 | 15 |
| PC coated by MW-RF PECVD | 0.7 | 1429 |

As shown, the MW-RF PECVD sample exhibited the lowest OTR and thus best barrier performance. Between the coated substrates, the MW-RF PECVD sample exhibited the better BIF compared to the LRF PECVD sample.

### Example 4

### Chemical Resistance and Optical Properties of SiOₓ Coated PC Film Using COMPACT-MW PECVD

Acetone testing performed to evaluate chemical resistance of uncoated (Sample B) and SiOₓ coated PC films by COMPACT-MW PECVD (Sample A). Acetone was used as aggressive organic solvent and was deposited on the surface of coated and uncoated PC films. The surface of the non-coated PC film became opaque after the addition of two drops acetone, while the surface of SiOₓ coated PC film did not exhibit any apparent change in the surface or in the transparency of the film. These results indicated better chemical resistance and homogeneity of SiOₓ coated PC film against strong chemical solvents.

Furthermore, luminous transmission (LT) and haze measurements were used to confirm the transparency of uncoated and SiOₓ coated samples both before and after the addition of acetone. Table 3 presents the values for the optical properties observed.

TABLE 3
Assessment of two plasma technologies for chemical resistance
and optical performance of polycarbonate and silica coated film.

| | Haze (%)/LT (%) | Haze (%)/LT (%) |
|---|---|---|
| Materials | Before Acetone | after Ex. Acetone |
| PC | 0.2/91.7 | 100/69.7 |
| PC coated by LRF PECVD | 0.3/92.1 | 14/89.2 |
| PC coated by MW-RF PECVD | 0.23/93.1 | 0.8/91.7 |

As shown in Table 3, a higher transmission value is observed for the coated PC substrates even after exposure to acetone. The MW-RF PECVD sample exhibited both the lowest haze and highest luminous transmittance after exposure to acetone. Thus the MW-RF PECVD sample exhibited the best chemical resistance to the acetone.

Table 4 illustrates various film properties of an inventive polycarbonate composition (EX11) including a PECVD film formed using both the radio frequency (RF) and microwave (MW) processes according to the present disclosure. Also illustrated are properties of prior art films including neat PC (CE5) and PET (CE6) and those including PCT and PET formed from LRF PECVD or MW processes (CE7-CE10). Also shown is a composition with a PECVD film formed on a PET-based composition (CE12) using both RF and MW processes.

TABLE 4
Comparison of properties of prior art films to inventive film.

| | Neat | | Plasma Technology | | | | | |
|---|---|---|---|---|---|---|---|---|
| | CE5 | CE6 | CE7 | CE8 | CE9 | CE10 | EX11 | CE12 |
| Properties | PC | PET | ¹LRF_{PC} | ¹LRF_{PET} | ²MW_{PC} | ²MW_{PET} | (RF + MW)_{PC} | ³(RF + MW)_{PET} |
| OTR | 1000 | 100 | 65 | 50 | 2.7 | 10⁰ | 10⁰-10⁻⁶ | 10⁰-0.3 |
| (cm³m⁻²d⁻¹bar⁻¹) | | | | | | | | |
| BIF | 1 | 1 | 15 | 2 | 370 | 100 | 1400 | 150 |
| Rₐ (nm) | <1 | <1 | 14 | 12 | <2 | <2 | <2 | <2 |
| LT (%) | >89 | >89 | >89 | >89 | >89 | >89 | >89 | >89 |
| Chemical resistance | Poor | Poor | Poor | Poor | Good | Good | Excellent | Good |
| (against Acetone) | H | H | H | H | H after | H after | T | T |
| | | | | | 10 min. | 10 min. | | |
| Company/supplier | SABIC | Mit. | Kaia | Kaia | Schott | KHS- | SABIC | University of |
| | | | | | Glas | GmbH | (Invention) | Bochum |

Note 1:
per US2012/0231182A1
Note 2:
per WO2003014415 A1
Note 3:
per J. Phys. D: Appl. Phys. 46 (2013) 084013
BIF = Barrier Improvement Factor
LT = Light Transmission
Ra = Roughness
H = Haze
T = Transparent
Mit. = Mitsubishi Chemicals
Kaia = Kaiatech Inc.
KHS = KHS-GmbH

As shown in Table 4, the prior art films (CE5-CE6 and CE12) had very high oxygen transmission rates (OTR) compared to the inventive composition (EX11). Even with the lower OTR, however, the inventive composition (EX11) maintained a high light transmission (>89%). Moreover, the chemical resistance of the prior art films is worse than that of the inventive composition. Further, the barrier improvement factor (BIF) of the inventive composition was substantially improved over the prior art compositions.

The disclosed subject matter associated with applying multiple plasma coating layers in a vacuum has been described with reference to several examples. It should be understood, however, that the words used are for descriptive and illustrative purposes, rather than as mere limitations. Although the methods and device for applying multiple plasma coating layers in a vacuum has been described in terms of particular means, processes, materials, technologies, and the like, the disclosed subject matter extends to functionally equivalent technologies, structures, methods, and uses that are within the scope of the claims.

1. A film formed by a process of plasma-enhanced chemical vapor deposition, the process comprising:
applying a radio frequency bias to a substrate; and
supplying a process gas through an antennae, where microwave power applied to the antennae generates plasma of the process gas at a surface of the substrate thereby forming one or more layers on the substrate to form the film,
wherein the film
has an oxygen transmission rate of between about 10⁻⁶ cm³/m²·day·bar and about 1 cm³/m²·day·bar when measured in accordance with ISO 15105-2,
exhibits a barrier improvement factor of greater than 1000 when compared to a substantially similar substrate,
exhibits a transmission of greater than about 88% at a 2.5 mm film thickness,
exhibits a surface roughness substantially similar to the surface roughness of a substantially similar substrate,
exhibits chemical resistance to organic solvents, and
has a surface roughness of less than about 2 nm.

2. A film formed by a process of plasma-enhanced chemical vapor deposition, the process comprising:
applying a radio frequency bias to a polycarbonate substrate; and
supplying a process gas through an antennae, where microwave power applied to the antennae generates plasma of the process gas at a surface of the polycarbonate substrate thereby forming one or more layers on the polycarbonate substrate and forming the film,
wherein the film has an oxygen transmission rate of between about 10⁻⁶ cm³/m²·day·bar and about 1 cm³/m²·day·bar when measured in accordance with ISO 15105-2, and wherein the film exhibits a transmission of greater than about 88% at a 2.5 mm film thickness.

3. The film of claim 2, the process further comprising causing an inert gas to activate a surface of the polycarbonate substrate prior to deposition of the one or more layers on the polycarbonate substrate.

4. The film of claim 2, wherein the film exhibits a barrier improvement factor of greater than 1000 when compared to a substantially similar polycarbonate substrate.

5. The film of claim 2, wherein the film exhibits a surface roughness substantially similar to the surface roughness of a substantially similar polycarbonate substrate.

6. The film of claim 2, wherein the film exhibits a surface roughness of less than about 2 nm.

7. The film of claim 2, wherein the polycarbonate substrate comprises a thin film.

8. The film of claim 1, wherein a layer of the one or more layers comprises an adhesion-promoting layer to facilitate adhesion of a successive layer.

9. The film of claim 1, wherein the antennae comprises a copper tube having an interior quartz coating and an exterior quartz coating.

10. The film of claim 9, wherein the microwave power generates a coaxial wave guide at the copper tube.

11. The film of claim 1, wherein the process gas comprises at least an organosilicon compound.

12. The film of claim 1, wherein the microwave power is applied at a frequency of about 2.45 GHz.

13. The film of claim 1, wherein the microwave power is provided at a power of up to about 2 kilowatts.

14. The film of claim 1, wherein the film exhibits a roughness profile having vertical deviations less than that of a substantially similar composite formed from a low radio frequency plasma-enhanced chemical vapor deposition process.

15. The film of claim 1, wherein the film has a haze of from about 0.01% to about 0.6%.

16. The film of claim 1, wherein the film has an oxygen transmission rate of between about 10⁻² cm³/m²·day·bar and about 1 cm³/m²·day·bar when measured in accordance with ISO 15105-2.

17. The film of claim 1, wherein the step of supplying a process gas to form the one or more layers on the substrate to form the film further comprises applying an atomic layer deposition process to the substrate, and wherein the film has an oxygen transmission rate between about 10⁻⁶ cm³/m²·day·bar and about 10⁻² cm³/m²·day·bar when measured in accordance with ISO 15105-2.

18. An article formed from the film of claim 1.

19. A method for microwave and radio frequency plasma-enhanced chemical vapor deposition on a substrate, the method comprising:
activating a surface of a polycarbonate substrate by treating the surface with an inert gas;
generating a dual-frequency plasma of a process gas by causing a radio frequency signal to be applied to the polycarbonate substrate and by causing microwave power to be applied to the process gas at the polycarbonate substrate; and
depositing one or more layers adjacent the surface of the polycarbonate substrate to form a film comprising the polycarbonate substrate and the one or more layers,
wherein the film exhibits an oxygen transmission rate of between about 10⁻⁶ cm³/m²·day·bar to about 1 cm³/m²·day·bar when measured in accordance with ISO 15105-2.

20. The method of claim 19, wherein the process gas and microwave frequency signal are delivered to the substrate via an antenna, the antennae comprising a tube.
